(19) United States
(12) Patent Application Publication
(10) Pub. No.: US 2020/0035178 A1
(43) Pub. Date: Jan. 30, 2020

(54) PIXEL SCAN METHOD, PIXEL SCAN DEVICE, DISPLAY APPARATUS AND COMPUTER READABLE STORAGE MEDIUM

(71) Applicants: BEIJING BOE SPECIAL DISPLAY TECHNOLOGY CO., LTD., Beijing (CN); BOE TECHNOLOGY GROUP CO., LTD., Beijing (CN)

(72) Inventor: Shihao WANG, Beijing (CN)

(21) Appl. No.: 16/432,290

(22) Filed: Jun. 5, 2019

(30) Foreign Application Priority Data
Jul. 27, 2018 (CN) 201810844582.X

(51) Int. Cl. G09G 3/36; G09G 3/3266

(52) U.S. Cl. CPC G09G 3/3674; G09G 2310/0213; G09G 3/3266

(57) ABSTRACT

A pixel scan method, a pixel scan device, a display apparatus and a computer readable storage medium are provided. The pixel scan method includes: acquiring data signals of each column in a display image of a display panel, and determining data information of the data signals of each column and a correspondence between the data information and pixel units; determining a first set of pixel units among pixel units of a column to which a first pixel unit belongs, and data information corresponding to the first set of pixel units is the same as data information corresponding to the first pixel unit; and inputting a data signal having the data information corresponding to the first pixel unit to the first pixel unit and the first set of pixel units.

### CROSS-REFERENCE TO RELATED APPLICATION

This application claims the benefit of Chinese Patent Application No. No. 201810844582.X, filed on Jul. 27, 2018, the contents of which are incorporated herein in their entirety by reference.

### TECHNICAL FIELD

The present disclosure relates to the field of display technology, and in particular relates to a pixel scan method, a pixel scan device, a display apparatus and a computer readable storage medium.

### BACKGROUND

In the display technology, the display apparatus is generally driven as follows. A control chip provides a control signal to a gate driver, and provides a control signal and encoded data signals to a source driver. When the control chip provides start signals to the gate driver and the source driver, the gate driver and the source driver sequentially turn on pixel driving circuits for pixel units according to a set frequency to turn on the pixel units and output data signals thereto, respectively, thereby completing a scan process.

### SUMMARY

According to an aspect of the present disclosure, there is provided a pixel scan method, including:

acquiring data signals of each column in a display image of a display panel, and determining data information of the data signals of the column and a correspondence between the data information and pixel units;

determining a first set of pixel units among pixel units of a column to which a first pixel unit belongs, wherein data information corresponding to the first set of pixel units is the same as data information corresponding to the first pixel unit; and

during a first stage, inputting a scan signal to pixel units of a row to which the first pixel unit belongs and pixel units of rows to which the first set of pixel units belong, to turn on pixel driving circuits of the pixel units of the row to which the first pixel unit belongs and the pixel units of the rows to which the first set of pixel units belong; and inputting a data signals having the data information corresponding to the first pixel unit to the first pixel unit and the first set of pixel units.

According to an embodiment of the present disclosure, the first pixel unit is a pixel unit at a first row and a first column among pixel units of the display panel.

According to an embodiment of the present disclosure, determining the data information of the data signals of each column includes determining same data signals among the data signals of the column in the display image to have same data information.

According to an embodiment of the present disclosure, determining the correspondence between the data information and the pixel units includes determining pixel units, to which a same data voltage is input, to correspond to the same data information.

According to an embodiment of the present disclosure, the method further includes, for pixel units in the column corresponding to same data information, storing one data signal corresponding to one pixel unit among the pixel units and an association between the pixel units and the one data signal.

According to an embodiment of the present disclosure, the method further includes, after the first stage,

determining a second set of pixel units among pixel units of a column to which a second pixel unit belongs, wherein data information corresponding to the second set of pixel units is the same as data information corresponding to the second pixel unit;

during a second stage, inputting the scan signal to pixel units of rows to which the second set of pixel units belong, to turn on pixel driving circuits of the pixel units of the rows to which the second set of pixel units belong; and inputting a data signal having the data information corresponding to the second pixel unit to the second pixel unit and the second set of pixel units, wherein the second pixel unit is a pixel unit at a first row and a second column among pixel units of the display panel.

According to an embodiment of the present disclosure, the method further includes, after the first stage, continuously inputting the scan signal to the pixel units of rows to which the first set of pixel units belong, until input of data signals to the pixel units of rows to which the first set of pixel units belong is completed.

According to an embodiment of the present disclosure, the method further includes, after the first stage, stopping input of the scan signal to the pixel units of rows to which the first set of pixel units belong, to turn off the pixel driving circuits of the pixel units of rows to which the first set of pixel units belong.

According to an embodiment of the present disclosure, the method further includes a data input process after the second stage, wherein the data input process includes:

determining an N^{th} set of pixel units among pixel units of an N^{th} column, wherein data information corresponding to the N^{th} set of pixel units is the same as data information corresponding to a pixel unit at a first row and a N^{th} column;

during an N^{th} stage, inputting the scan signal to pixel units of rows to which the N^{th} set of pixel units belong, to turn on pixel driving circuits of the pixel units of the rows to which the N^{th} set of pixel units belong; and inputting a data signals having the data information corresponding to the pixel unit at the first row and the N^{th} column to the pixel unit at the first row and the Nth column and the N^{th} set of pixel units,

wherein the data input process is performed starting from N=3 and N is incremented by 1 once the data input process is completed, until N−1 is equal to a total number of columns of all pixel units in the display panel.

According to an embodiment of the present disclosure, the method further includes, after the N^{th} stage,

determining, among pixel units at the first column and other rows other than the first row, a third set of pixel units of which data information is the same as data information corresponding to a pixel unit at a second row and a first column, in response to the data information corresponding to the pixel unit at the second row and the first column being different from the data information corresponding to the pixel unit at the first row and the first column;

during an (N+1)^{th} stage, inputting the scan signal to pixel units of rows to which the third set of pixel units belong and of which pixel driving circuits have not been turned on, to turn on pixel diving circuits of the pixel units of rows to which the third set of pixel units belong and of which pixel driving circuits have not been turned on; and inputting a data signal having the data information corresponding to the pixel unit at the second row and the first column to the pixel unit at the second row and the first column and the third set of pixel units, wherein N is equal to the total number of columns of all pixel units in the display panel.

According to an embodiment of the present disclosure, the method further includes:

skipping the pixel unit at the second row and the first column without inputting a data signal to the pixel unit at the second row and the first column, in response to the data information corresponding to the pixel unit at the second row and the first column being the same as the data information corresponding to the pixel unit at the first row and the first column.

According to an embodiment of the present disclosure, the method further includes:

in a case where input of the data signals is performed on pixel units of reminder rows, pixel units to which the data signals have been input are skipped and the data signals are input only to pixel units to which the data signals have not been input.

According to another aspect of the present disclosure, there is provided a pixel scan device including:

a data processor, configured to acquire data signals of each column in a display image of a display panel, and determine data information of the data signals of the column and a correspondence between the data information and pixel units; and determine a first set of pixel units among pixel units of a column to which a first pixel unit belongs, wherein data information corresponding to the first set of pixel units is the same as data information corresponding to the first pixel unit;

a gate driving circuit configured to, during a first stage, input a scan signal to pixel units of a row to which the first pixel unit belongs and pixel units of rows to which the first set of pixel units belong, to turn on pixel driving circuits of the pixel units of the row to which the first pixel unit belongs and the pixel units of the rows to which the first set of pixel units belong;

a source driving circuit configured to, during the first stage, input a data signal having the data information corresponding to the first pixel unit to the first pixel unit and the first set of pixel units.

According to an embodiment of the present disclosure, the device further includes a data memory, configured to for pixel units in the column corresponding to same data information, store one data signal corresponding to one pixel unit among the pixel units and an association between the pixel units and the one data signal.

According to another aspect of the present disclosure, there is provided a display apparatus including a processor, a gate driving circuit, a source driving circuit and a plurality of pixel units, each of the plurality of pixel units including a pixel driving circuit, the processor being electrically coupled to the gate driving circuit and the source driving circuit, and the pixel driving circuit of each of the plurality of pixel units being electrically coupled to the gate driving circuit and the source driving circuit,

wherein the processor is configured to acquire data signals of each column in a display image of a display panel, determine data information of the data signals of the column and a correspondence between the data information and pixel units, and determine a first set of pixel units among pixel units of a column to which a first pixel unit belongs, wherein data information corresponding to the first set of pixel units is the same as data information corresponding to the first pixel unit;

the gate driving circuit is configured to, during a first stage, input a scan signal to pixel units of a row to which the first pixel unit belongs and pixel units of rows to which the first set of pixel units belong, to turn on pixel driving circuits of the pixel units of the row to which the first pixel unit belongs and the pixel units of the rows to which the first set of pixel units belong;

the source driving circuit is configured to, during the first stage, input a data signal having the data information corresponding to the first pixel unit to the first pixel unit and the first set of pixel units.

According to an embodiment of the present disclosure, the gate driving circuit includes a first bidirectional shift register and a channel selector electrically coupled with each other; the channel selector being electrically coupled to the pixel driving circuit of each of the pixel units; and

the processor is configured to control the first bidirectional shift register to transmit a high level signal for controlling the pixel driving circuits of pixel units of each row to the channel selector; control the channel selector, according to the high level, to turn on the pixel driving circuits of the pixel units of the row to which the first pixel unit belongs and the pixel units of the rows to which the first set of pixel units belong, during the first stage.

According to an embodiment of the present disclosure, the source driving circuit includes a second bidirectional shift register electrically coupled to the pixel driving circuit of each of the pixel units through a signal line; and

the processor is configured to control the second bidirectional shift register to input the data signal having the data information corresponding to the first pixel unit to the first pixel unit and the first set of pixel units of which the pixel driving circuits have been turned on.

According to another aspect of the present disclosure, there is provided a computer readable storage medium having stored thereon a computer program, the computer program being executed by a processor to implement the method according to the embodiments of the present disclosure.

The additional aspects and advantages of the present disclosure will be partly set forth in the following description, which will be clear from the following description, or known through the practice of the present disclosure.

### BRIEF DESCRIPTION OF THE DRAWINGS

The above aspects and advantages of the present disclosure will become apparent and readily understood in the following description of the embodiments in conjunction with the following drawings, in which:

FIG. 1 is a schematic structural diagram of a framework of a display apparatus and a correspondence between data information and pixel units according to an embodiment of the present disclosure;

FIG. 2 is a schematic structural diagram of a framework of another display apparatus and a correspondence between data information and pixel units according to an embodiment of the present disclosure;

FIG. 3 is a schematic flowchart diagram of a pixel scan method according to an embodiment of the present disclosure;

FIG. 4 is a schematic flowchart diagram of another pixel scan method according to an embodiment of the present disclosure; and

FIG. 5 is a schematic structural diagram of a framework of a pixel scan device according to an embodiment of the present disclosure.

### DETAILED DESCRIPTION

The present disclosure will be described in detail below with reference to the embodiments of the present invention, in which the same or similar reference numerals refer to the same or similar components or components having the same or similar functions. Further, if a detailed description of a known technique is unnecessary for the features of the present disclosure shown, the detailed description is omitted. The embodiments described below with reference to the accompanying drawings are for the purpose of illustration and explanation only and not intended to limit the present disclosure.

Those skilled in the art will understand that all terms (including technical and scientific terms) used herein have the same meaning as commonly understood by those skilled in the art to which the present disclosure belongs, unless otherwise defined. It should also be understood that terms such as those defined in a general dictionary should be understood to have meaning consistent with the meaning in the context of the prior art, and will not be explained by idealized or excessive formal meanings unless specifically defined as here.

Those skilled in the art will understand that the term “a”, “an”, “the” may include two or more. It should be understood that the phrase “comprise” or “include” used in the specification of the present disclosure, is intended to mean the presence of the feature, integer, step, operation, element and/or component, but does not exclude the presence or addition of one or more other features, integers, steps, operations, elements, components, and/or group thereof. It will be understood that when an element is referred to as being “connected” or “coupled” to another element, it can be directly connected or coupled to the other element or there is an intermediate element therebetween. Further, “connected” or “coupled” as used herein may include either a wireless connection or a wireless coupling. The phrase “and/or” used herein includes all of one or more of the associated listed items or any unit and all combinations thereof

The technical solutions of the present disclosure and how the technical solutions of the present disclosure solve the above technical problems will be described in detail below with reference to specific embodiments. The following specific embodiments may be combined with each other, and the same or similar concepts or processes may not be described in some embodiments. Embodiments of the present disclosure will be described below with reference to the accompanying drawings.

The common scan process usually includes turning on pixel units row by row starting from a first row; for a row of pixel units being turned on, the source driver sequentially transmits the data signals to the pixel driving circuits for the row of pixel units from one direction to the other direction, until all the data signals in one entire frame has been transmitted.

However, in this scan manner, for a pixel array composed of a plurality of rows of pixel units and a plurality of columns of pixel units, it is necessary to transmit the data signal to an individual pixel unit one by one, which results in a low scan frequency. Therefore the refresh rate of the displayed image is relatively low, which affects the user experience.

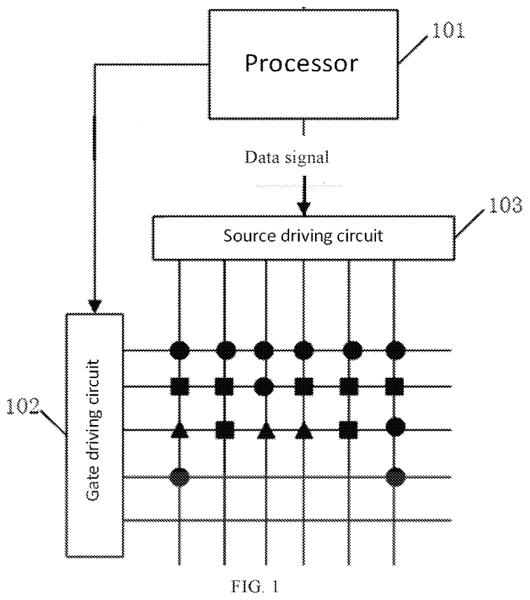

As shown in FIG. 1, an embodiment of the present disclosure provides a display apparatus including a processor 101, a gate driving circuit 102, a source driving circuit 103 and a plurality of pixel units, Each of the plurality of pixel units includes a pixel driving circuit. The processor 101 is electrically coupled to the gate driving circuit 102 and the source driving circuit 103. Each of the pixel driving circuits of the plurality of pixel units is electrically coupled to the gate driving circuit 102 and the source driving circuit 103.

The processor 101 is configured to acquire data signals of each column (here, the data signals of each column represent data signals to be input to the pixel driving circuits of pixel units of each column, such as data voltages) in a display image of a display panel to determine data information (here, the data information may represent a magnitude of the data voltage. That is, data signals having different data information represent the data signals having data voltages with varying values, and data signals having the same data information represent data signals having the same data voltages) of the data signals of each column and a correspondence between the data information and the pixel units of the column. The processor 101 is further configured to store a data signal corresponding to the data information in each column and an association between the pixel units and the data signals. The processor is further configured to determine a first set of pixel units among pixel units of a first column according to the data information and the correspondence, wherein the data information corresponding to the first set of pixel units is the same as the data information corresponding to a pixel unit at a first row and a first column. Here, the pixel unit at the first row and the first column may be one of the pixel units of the row which are firstly scanned by the gate driving circuit 102.

Optionally, when storing the data signal corresponding to data information in each column and the association between the data signals and the pixel units, the processor 101 is specifically configured to, for pixel units in the column corresponding to same data information, store one data signal corresponding to any one of pixel units and the association between the pixel units and the one data signal. The circle pattern, square pattern, and triangular pattern shown in FIG. 1 may represent data signal associated with each pixel unit. For pixel units of each column, patterns of different shapes represent data signal having different data information. As an example, referring to FIG. 1, in the pixel units of the first column, the data information corresponding to the pixel unit of the first row is the same as the data information corresponding to the pixel unit of the fourth row. In the pixel units of the second column, the data information corresponding to the pixel unit of the second row is the same as the data information corresponding to the pixel unit of the third row. It should be noted that although the data signals corresponding to the pixel units of the first row are shown by the circle pattern in FIG. 1, data signals corresponding to the pixel units of the first row may have different data information.

Optionally, the gate driving circuit 102 is electrically coupled to a plurality of pixel units through scan lines, and the source driving circuit 103 is electrically coupled to the plurality of pixel units through signal lines. The scan lines are shown as horizontal lines coupled to the gate driving circuit 102 in FIG. 1, the signal lines are shown as vertical lines coupled to the source driving circuit 103 in FIG. 1, and one pixel unit may be defined at the intersection between one horizontal line and one vertical line.

The gate driving circuit 102 is configured to, during a first stage, input a scan signal to pixel units of the first row and pixel units of rows to which the first set of pixel units belong, to turn on pixel driving circuits of pixel units of the first row and pixel units of rows to which the first set of pixel units belong.

The source driving circuit 103 is configured to, during the first stage, input the data signal having the data information corresponding to the first pixel unit to the pixel unit at the first row and the first column and the first set of pixel units.

Optionally, the gate driving circuit 102 includes a first bidirectional shift register and a channel selector electrically coupled with each other. The channel selector is electrically coupled to the pixel driving circuit of each of the pixel units through the scan line. The processor 101 is configured to control the first bidirectional shift register to transmit a high level signal for controlling the pixel driving circuits of pixel units of each row to the channel selector, to turn on the pixel driving circuits of the pixel units of the first row and the pixel units of the rows to which the first set of pixel units belong, during the first stage.

The first bidirectional shift register in the embodiment of the present disclosure may adopt a general bidirectional shift register, the specific operating principle thereof can be understood by those skilled in the art, and details are not described herein.

The channel selector in the embodiment of the present disclosure may adopt a general channel selector for selecting more than one channel. The specific number of the channels that the channel selector can select may be determined according to the number of rows of the pixel units, or determined according to other actual needs. Those skilled in the art may understand the specific operating principle of the channel selector and how the channel selector implements the functions of the present disclosure, which will not be described herein.

Optionally, the source driving circuit 103 includes a second bidirectional shift register electrically coupled to the pixel driving circuit of each of the pixel units through the signal line. The processor 101 is configured to control the second bidirectional shift register to output the data signals to the pixel driving circuits of the pixel unit at the first row and the first column and the first set of pixel units which have been turned on.

The second bidirectional shift register in the embodiment of the present disclosure may adopt a general bidirectional shift register, the specific operating principle thereof can be understood by those skilled in the art, and details are not described herein.

Those skilled in the art can understand that the gate driving circuit 102 and the source driving circuit 103 provided by the embodiments of the present disclosure may further include other general-purpose components, such as a repair buffer, which are not listed herein.

The circuit structure of the pixel driving circuit of each pixel unit in the embodiment of the present disclosure includes: a thin film transistor (TFT) and a capacitor electrically coupled with each other. Those skilled in the art can understand connection among the TFT, the capacitor, the scan line, and the signal line. The scan of the pixel unit in the embodiment of the present disclosure includes the process of turning on the TFT, charging the capacitor, etc., and the specific principles thereof can be understood by those skilled in the art and are not described herein.

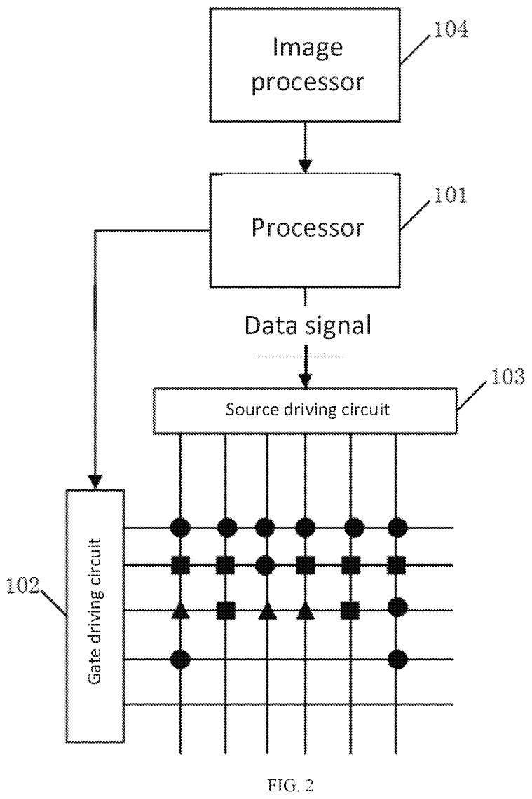

Optionally, as shown in FIG. 2, the display apparatus provided by the embodiment of the present disclosure may further include: an image processor 104 electrically coupled to the processor 101. In the embodiment of the present disclosure, the functions of acquiring data signals of each column in a display image of a display panel and determining data information on data signals of each column and a correspondence between the data information and pixel units can be performed by the image processor 104.

Optionally, the display apparatus provided by the embodiment of the present disclosure further includes: a memory (not shown in FIG. 1 and FIG. 2) which may be disposed in the processor 101. The memory may be configured to, for pixel units corresponding to data signals of the same column having the same data information, store one data signal corresponding to any one of the pixel units and an association between the pixel units and the data signal.

The processor 101 in the embodiment of the present disclosure may be a Timer Control Register (ICON), a Central Processing Unit (CPU), a general-purpose processor, a Digital Signal Processor (DSP), an Application Specific Integrated Circuit (ASIC), a Field-Programmable Gate Array (FPGA) or other programmable logic device, a transistor logic device, a hardware component, or any combination thereof, which may implement or carry out various illustrative logical blocks, modules and circuits described in connection with the present disclosure. The processor 101 can also be a combination of implementing computing functions, such as a combination including one or more microprocessor, a combination of a DSP and a microprocessor, and the like.

The memory in the embodiment of the present disclosure may be a ROM (Read-Only Memory) or other type of static storage device that can store static information and instructions, and may be a RAM (random access memory) or may be other types of dynamic storage devices that store information and instructions, and may also be an EEPROM (Electrically Erasable Programmable Read Only Memory), CD-ROM (Compact Disc Read-Only Memory), or other disc storages, an optical disc storage (including compact discs, laser discs, optical discs, digital versatile discs, blue-ray discs, etc.), magnetic disk storage medium or other magnetic storage devices, or any other medium capable of carrying or storing the desired program codes having form of instructions or data structures and that can be accessed by a computer, but is not limited thereto.

The specific principle of the display apparatus provided by the embodiment of the present disclosure will be described in detail in the following method embodiments, and details are not described herein.

At least the following beneficial effects can be achieved by applying the embodiments of the present disclosure:

1) for a column of pixel units, by determining data information of each data signal and a correspondence between each data information and each pixel unit, the data signals may be simultaneously input to more than one pixel unit in the column according to the data information and the correspondence;

2) when there are two or more data signals having the same data information, the number of scan times for the column can be effectively reduced by scanning two or more rows of pixel units at the same time, which results in saved scan time, and thus the refresh frequency of the display image can be improved;

3) for the same data signals (that is, the data signals having the same data information), only one data signal is stored according to an embodiment without storing the data signal several times. Therefore the buffer can be effectively reduced and the storage space can be saved; and

4) in the gate driving circuit and the source driving circuit provided by the embodiments of the present disclosure, the gate driving circuit is provided with the channel selector which can control the pixel driving circuits of pixel units of a certain row to be turned on while controlling the pixel driving circuits of pixel units of other rows having the same association relationship (i.e., corresponding to the same data information) to be turned on, thereby realizing scan of more than two rows of pixel units at the same time.

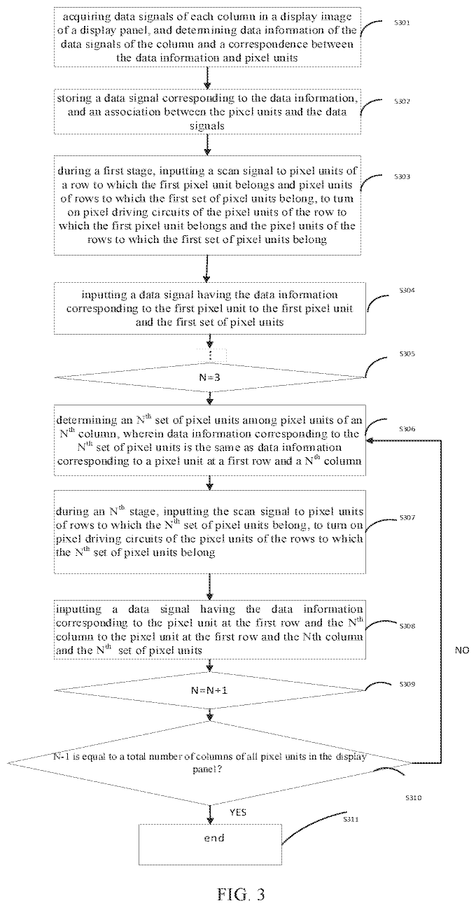

The embodiment of the present disclosure provides a pixel scan method. The schematic diagram of the pixel scan method is as shown in FIG. 3, and includes steps S301 to S304.

The step S301 includes acquiring data signals of each column in a display image of a display panel, and determining data information of data signals of the column and a correspondence between the data information and pixel units;

Optionally, determining data information of data signals of the column includes determining whether at least two same data signals are present in data signals of the column in the display image; if yes, determining that the at least two same data signals have the same data information.

Optionally, determining the correspondence between the data information and pixel units includes determining pixel units to which a same data voltage is input to correspond to the same data information.

The step S302 includes storing the data signals corresponding to the data information and the association between the pixel units and the data signals.

Optionally, for pixel units in the same column corresponding to same data information, one data signal corresponding to one pixel unit among the pixel units and the association between the pixel units and the one data signal are stored.

The step S303 includes, during the first stage, inputting a scan signal to pixel units of the first row and pixel units of rows to which the first set of pixel units belong, to turn on the pixel driving circuits of pixel units of the first row and pixel units of rows to which the first set of pixel units belong. The first set of pixel units are pixel units among the pixel units of the first column which correspond to the same data information as the pixel unit at the first row and the first column.

The step 304 includes, during the first stage, inputting the data signal having the data information corresponding to the pixel unit at the first row and the first column to the pixel unit at the first row and the first column and the first set of pixel units.

At least the following beneficial effects can be achieved by applying the embodiments of the present disclosure:

1) for a column of pixel units, by determining data information of each data signal and a correspondence between each data information and each pixel unit, the data signals may be simultaneously input to more than one pixel unit in the column according to the data information and the correspondence;

2) when there are two or more data signals having the same data information, the number of scan times can be effectively reduced by scanning two or more rows of pixel units at the same time, which results in saved scan time, and thus the refresh frequency of the display image can be improved; and

3) for the same data signals (that is, the data signals having the same data information), only one data signal is stored according to an embodiment without storing the data signals. Therefore the buffer can be effectively reduced and the storage space can be saved.

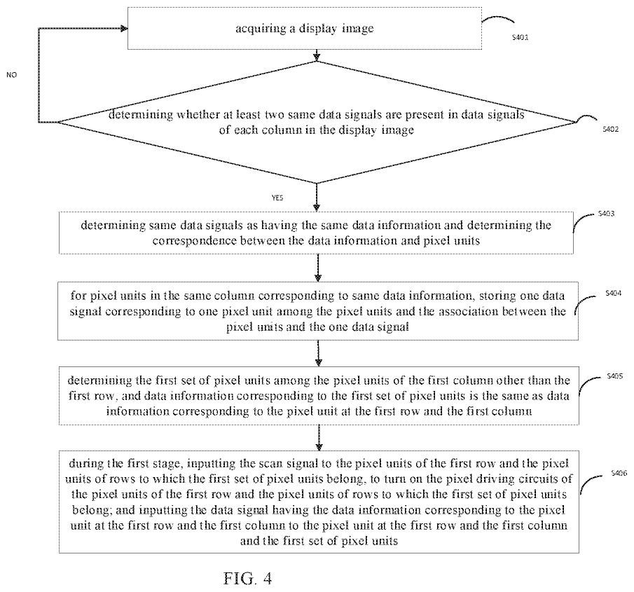

FIG. 4 shows a flow chart illustrating a pixel scan method provided by an embodiment of the present disclosure. As shown in FIG. 4, the method includes steps S401 to S406.

The step S401 includes acquiring a display image.

Optionally, the display image of the embodiment of the present disclosure is a frame of image.

The step S402 includes determining whether at least two same data signals are present in data signals of each column in the display image; if yes, the step S403 is performed, and otherwise the step S401 is performed.

Taking FIG. 1 as an example, in the step S402, the data signals of the first column can be compared with each other to determine whether some data signals represented by a pattern of the same shape are present in the data signals of the first column, and if yes, performing the step S403. Based on the similar principle, the data signals of reminder columns may be compared and determined by the step S402.

The step S403 includes determining same data signals as having the same data information and determining the correspondence between the data information and pixel units.

Taking FIG. 1 as an example, the data signals represented by the pattern of the same shape are determined as having the same data information. In FIG. 1 and the step S403, it may be determined that data signals represented by a circle pattern have the same data information, data signals represented by a square pattern have the same data information; and the data signals represented by a triangle pattern have the same data information

Optionally, a one-to-one correspondence between the same data information of the data signals and the pixel units is determined.

Taking FIG. 1 as an example, the one-to-one correspondence between the black circle pattern, the square pattern and the triangle pattern and the respective pixel units defined at the intersections of the scan lines and signal lines is determined, which is shown in FIG. 1.

The step S404 includes for pixel units in the same column corresponding to same data information, storing one data signal corresponding to one pixel unit among the pixel units and the association between the pixel units and the one data signal.

In the step S404, for the same data signals in the same column, any one data signal may be stored, without storing all same data signals in the same column. The stored data signal is associated with the pixel units corresponding to the same data information in the same column. In the subsequent data output process, when a plurality of pixel units are associated with the stored data signal, the stored data signal needs to be output a plurality of times, that is, the stored data signal is output to the plurality of pixel units having the association relationship, respectively.

This step can greatly reduce the buffer while satisfying the output of the data signal to each pixel unit.

The step S405 includes determining the first set of pixel units among the pixel units of the first column other than the first row, and data information corresponding to the first set of pixel units is the same as data information corresponding to the pixel unit at the first row and the first column.

The step S406 includes, during the first stage, inputting the scan signal to the pixel units of the first row and the pixel units of rows to which the first set of pixel units belong, to turn on the pixel driving circuits of the pixel units of the first row and the pixel units of rows to which the first set of pixel units belong; and inputting the data signal having the data information corresponding to the pixel unit at the first row and the first column to the pixel unit at the first row and the first column and the first set of pixel units.

The following detailed description of a possible scan process of pixel units will be made by taking M×N pixel units (where M and N are positive integers) composed of M rows and N columns as an example.

The first pixel scan process can be made by the following process.

During the first stage, the gate driving circuit 102 turns on all the pixel driving circuits of the row to which the first pixel unit belongs. If some other pixel units in the column to which the first pixel unit belongs and the first pixel unit are associated with the same data signal, these some other pixel units are determined as the first set of pixel units, and all the pixel driving circuits of the rows to which the first set of pixel units belong are turned on during the first stage. If no pixel unit of in column to which the first pixel unit belongs and the first pixel unit are associated with the same data signal, it is not necessary to turn on the pixel driving circuits of other rows.

In the first pixel scan process, the first pixel unit may be designated according to actual needs. For example, the pixel unit at the first row and the first column may be set as the first pixel unit, or the pixel unit at an I^{th} (I is a positive integer greater than 0 and less than or equal to M) row and the first column may be set as the first pixel unit.

If all the pixel driving circuits of the pixel units of the row to which the first pixel unit belongs and all the pixel driving circuits of the pixel units of rows to which the first set of pixel units belong are turned on, the source driving circuit 103 is controlled to input the associated data signal to the pixel driving circuit of the first pixel unit and the pixel driving circuits of the first set of pixel units during the second stage. After completing the input of the associated data signal, all the pixel driving circuits of the rows to which the first set of pixel units belong are turns off, and the pixel driving circuits of the row to which the first pixel unit belongs are maintained to be turned on. If all the pixel driving circuits of the row to which the first pixel unit belongs are turned on, the associated data signal only needs to be input to the pixel driving circuit of the first pixel unit.

Therefore, the first pixel scan process may be understood as completing the input of the data signals to the first pixel unit and the first set of pixel units.

After the first pixel scan process is completed, a second pixel scan process can be performed in the following manner.

A next pixel unit of the row to which the first pixel unit belongs (for example, the pixel unit at the first row and the second column) is referred to as a second pixel unit. If some other pixel units of the column to which the second pixel unit belongs and the second pixel unit are associated with the same data signal, these some other pixel units are determined as the second set of pixel units. The gate driving circuit 102 is controlled to turn on all the pixel driving circuits of the rows to which the second set of pixel units belong during the second stage. If no pixel unit of the column to which the second pixel unit belongs and the second pixel unit are associated with the same data signal, it is not necessary to turn on the pixel driving circuits of other rows.

If all the pixel driving circuits of the pixel units of the row to which the second pixel unit belongs and all the pixel driving circuits of the pixel units of rows to which the second set of pixel units belong are turned on, the source driving circuit 103 is controlled to input the associated data signal to the pixel driving circuit of the second pixel unit and the pixel driving circuits of the second set of pixel units during the second stage. After completing the input of the associated data signal, all the pixel driving circuits of the rows to which the second set of pixel units belong are turns off, and the pixel driving circuits of the row to which the second pixel unit belongs are maintained to be turned on. If all the pixel driving circuits of the row to which the second pixel unit belongs are turned on, the associated data signal only needs to be input to the pixel driving circuit of the second pixel unit.

Therefore, the second pixel scan process may be understood as completing the input of the data signal to the second pixel unit and the second set of pixel units.

According to an embodiment of the present disclosure, the method further includes a data input process after the second stage, wherein the data input process includes:

determining an N^{th} set of pixel units among pixel units of an N^{th} column such that data information corresponding to the N^{th} set of pixel units is the same as data information corresponding to a pixel unit at a first row and an N^{th} column (S306);

during an N^{th} stage, inputting the scan signal to pixel units of rows to which the N^{th} set of pixel units belong, to turn on pixel driving circuits of the pixel units of the rows to which the N^{th} set of pixel units belong (S307); and inputting data signal to the pixel unit at the first row and the N^{th} column and the N^{th} set of pixel units (S308), and

the data input process is performed starting from N=3 (S305) and N is incremented by 1 once the data input process is performed (S309), until N−1 is equal to a total number of columns of all pixel units in the display panel (S310-S311),

According to an embodiment of the present disclosure, the pixel scan process further includes, after the N^{th} stage,

determining, among pixel units at the first column and other rows other than the first row, a third set of pixel units of which data information is the same as data information corresponding to a pixel unit at a second row and a first column in response to the data information corresponding to the pixel unit at the second row and the first column being different from the data information corresponding to the pixel unit at the first row and the first column;

during an (N+1)^{th} stage, inputting the scan signal to pixel units of rows to which the third set of pixel units belong and of which the pixel driving circuits have not been turned on, to turn on the pixel diving circuits of the pixel units of rows to which the third set of pixel units belong and of which the pixel driving circuits have not been turned on; and inputting the data signal having the data information corresponding to the pixel unit at the second row and the first column to the pixel unit at the second row and the first column and the third set of pixel units, and N is equal to the total number of columns of all pixel units in the display panel.

According to an embodiment of the present disclosure, the pixel scan process further includes:

skipping the pixel unit at the second row and the first column without inputting the data signal to the pixel unit at the second row and the first column in response to the data information corresponding to the pixel unit at the second row and the first column being the same as the data information corresponding to the pixel unit at the first row and the first column.

According to an embodiment of the present disclosure, in a case where the input of the data signal is performed on pixel units of reminder rows, pixel units to which the data signals have been input are skipped and the data signals are input only to pixel units to which the data signals are not input, which can save the total time to input data signals to all pixel units of the display panel.

Therefore, according to the embodiment of the present disclosure, the data signals may be input to pixel units of a row, and pixel units of which data information is same with each pixel unit of the row among pixel units of columns to which each of the pixel units of the row belongs, by the steps S301 to S311 shown in FIG. 3.

By adopting the above-mentioned pixel unit scan and data signal input method, the scan of the pixel units of each row and the input of the data signals to the pixel units of each row can be completed in sequence until the scan of the pixel units of each row and the input of the data signals to pixel units of the M rows are completed by M times of line scans, thereby completing the scan of all pixel units and input of data signals to all pixel units.

In the prior art, the scan is preformed row by row. During the row scan process, the data signal is input one by one for pixel units of each row. Thus the input of the data signal to all the pixel units can be completed by M×N times of the input of the data signal. In the above scan method provided by the embodiment of the present disclosure, if the number of times of skipping is L (L is an integer greater than 0), the embodiment of the present disclosure can complete the input of the data signal to the all pixel units by (M×N−L) times of the input of the data signal, which can greatly reduce the number of times of input of the data signal, thereby saving the input time of the data signal and increasing the image refresh frequency.

For pixel units of the same column, when pixel unit of one row is associated with the same data signal as pixel unit of another row, all pixel driving circuits of pixel units of the two rows can be simultaneously turned on, and all pixel driving circuits of pixel units of the two rows are maintained to be turned on during the entire row scan process, to reduce the number of times of repeatedly turning on or off the same row of pixel driving circuits. In addition, the situation can be extended to a plurality of rows of pixel units to further save scan time and further improve the refresh rate of the displayed image.

The scan manner will be further described by taking the pixel units shown in FIG. 1 as an example.

Taking FIG. 1 as an example, during the first stage, the gate driving circuit 102 is controlled to turn on the pixel driving circuits of the pixel units of the first row. Since among the pixel units of the first column, the pixel unit of the first row and the pixel unit of the fourth row are associated with the data signal corresponding to the circle pattern, all the pixel driving circuits of the pixel units of the fourth row are turned on at the same time with the pixel driving circuits of the pixel units of the first row during the first stage. During the first stage, the source driving circuit 103 is controlled to input the data signal corresponding to the associated circle pattern to the pixel driving circuits of the pixel unit at the first row and the first column and the pixel unit at the fourth row and the first column, and turn off the pixel driving circuits of the pixel units of the fourth row after the input of the data signal, to complete the input of the data signal to the pixel unit at the first row and the first column and the pixel unit at the fourth row and the first column.

Optionally, if the pixel units of the fourth row and the pixel units of the first row are associated with the data signal having the same data information respectively, it is not necessary to turn oft all pixel driving circuits of the pixel units of the fourth row and maintaining all pixel driving circuits of the pixel units of the fourth row to be turned on after the data signal is input to the pixel driving circuits of the pixel unit at the first row and the first column and the pixel unit at the fourth row and the first column, until input of the data signal to all the pixel units of the first row and the fourth row is completed.

Since among the pixel units of the second column, no pixel unit associated with the data signal corresponding to the circle pattern other than the pixel unit at the first row and the second column, the data signal corresponding to the circle pattern is input to only the pixel driving circuit of the pixel unit at the first row and the second column during the second stage.

Since among the pixel units of the third column, the pixel units of the first row and the second row are both associated with the data signal corresponding to the circle pattern, during the third stage, all pixel driving circuits of the pixel units of the second row and turned on, and the source driving circuit 103 is controlled to input the data signal corresponding to the associated circle pattern to the pixel driving circuits of the pixel unit at the first row and the third column and the pixel unit at the second row and the third column, after which the pixel driving circuits of the pixel units of the second row are turned off, to complete input of the data signal to the pixel unit at the first row and the third column and the pixel unit at the second row and the third column.

The scans of the other pixel units of the first row and the previous two pixel units of the second row are similar to those for the pixel unit at the first row and the first column, and will not be described herein. Since the data signal has been input to the pixel unit at the second row and the third column while the data signal was input to the pixel unit at first row and the third column, the pixel unit at the second row and the third column can be skipped during the input of the data signals to the pixel units of the second row (that is, after the input of the data signal to the pixel unit at the second row and the second column is completed, the data signal is immediately input to the pixel unit at the second row and the fourth column). The process of inputting data signals to pixel units of other rows is similar to the pixel units of the second row, which will not be described herein.

At least the following beneficial effects can be achieved by applying the embodiments of the present disclosure:

1) for a column of pixel units, by determining data information of each data signal and a correspondence between each data information and each pixel unit, the data signal may be simultaneously input to more than one pixel unit in the column according to the data information and the correspondence; considering that in many cases, there are many data signals having the same data information in one frame of display image, the embodiment of the present disclosure can greatly reduce the number of times of inputting the data signal, thereby improving the refresh frequency of the display image.

2) when there are two or more data signals having the same data information, the number of scan times can be effectively reduced by scanning two or more rows of pixel units at the same time, which results in saved scan time, and thus the refresh frequency of the display image can be improved;

3) for the same data signals (that is, the data signals having the same data information), only one data signal is stored according to an embodiment without storing the data signals. Therefore the buffer can be effectively reduced and the storage space can be saved; and

4) for a plurality of rows of pixel units, when each pixel unit of each row and the corresponding pixel units of the other rows are associated with the same data signal, all the pixel driving circuits of the plurality of rows can be simultaneously turned on and pixel units of the plurality of rows can be simultaneously scanned. The pixel driving circuits of the plurality of rows are maintained to be turned on during the entire row scan process. Therefore the number of times of repeatedly turning on or off the pixel driving circuits of the same row can be reduced, the scan time can be further saved and the refresh rate of the display image can be further improved.

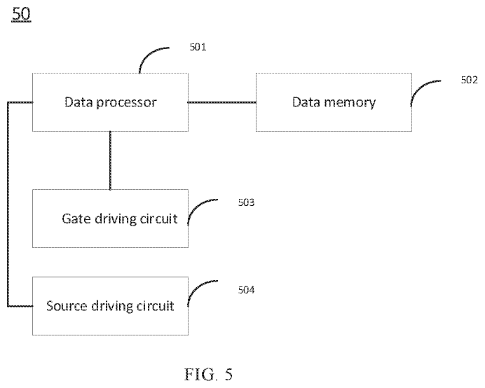

An embodiment of the present disclosure provides a pixel scan device. FIG. 5 shows a schematic structural diagram of a framework of the pixel scan device 50 including a data processor 501, a data memory 502, a gate driving circuit 503 and a source driving circuit 504.

The data processor 501 is configured to acquire data signals of each column in a display image of a display panel, determine data information of the data signals of the column and a correspondence between the data information and pixel units; and determine a first set of pixel units among pixel units of a column to which a first pixel unit belongs, and data information corresponding to the first set of pixel units is the same as data. information corresponding to the first pixel unit.

The data memory 502 is configured to store a data signal corresponding to the data information, and an association between the pixel units and the data signals.

The gate driving circuit 503 is configured to, during a first stage, input a scan signal to pixel units of a row to which the first pixel unit belongs and pixel units of rows to which the first set of pixel units belong, to turn on pixel driving circuits of the pixel units of the row to which the first pixel unit belongs and the pixel units of the rows to which the first set of pixel units belong.

The source driving circuit 504 is configured to, during the first stage, input the data signal to the first pixel unit and the first set of pixel units.

The pixel scanning device 50 of the present embodiment can perform the pixel scan method provided by the embodiment of the present disclosure, and the implementation principle and the beneficial effects thereof are similar to the pixel scan method, and details are not described herein.

The embodiment of the present disclosure provides a computer readable storage medium having stored thereon a computer program, which is executed by the processor 101 to implement the pixel scan method provided by the embodiment of the present disclosure.

The computer readable storage medium includes, but is not limited to, any type of disk (including floppy disk, hard disk, optical disk, CD-ROM, and magneto-optical disk), ROM, RAM, EPROM (Erasable Programmable Read-Only Memory), EEPROM, flash memory, magnetic card or light card. That is, the readable storage medium includes any medium through which information is stored or transmitted by an apparatus (e.g., a computer) in a readable form.

The computer readable storage medium provided in the embodiment of the present disclosure has the same inventive concept and the same advantageous effects as the previous embodiments, and details are not described herein.

Those skilled in the art can understand that the steps, measures, and solutions of various operations, methods, flows discussed in the present disclosure may be alternated, modified, combined, or deleted. Further, other steps, measures, and solutions having various operations, methods, flows discussed in the present disclosure may be alternated, modified, rearranged, decomposed, combined, or deleted. Furthermore, steps, measures, and solutions in the prior art having various operations, methods, flows discussed in the present disclosure may be alternated, modified, rearranged, decomposed, combined, or deleted.

It should be understood that although the various steps in the flowchart of the drawings are sequentially displayed as indicated by the arrows, these steps are not necessarily performed in the order indicated by the arrows. Except as explicitly stated herein, the execution of these steps is not strictly limited, and may be performed in other sequences. Moreover, at least some of the steps in the flowchart of the drawings may include a plurality of sub-steps or stages, which are not necessarily performed at the same time, but may be executed at different times, and the execution order thereof is also not necessarily performed sequentially, but may be performed in turn or alternately with at least a portion of other steps or sub-steps or stages of other steps.

The above description is only a partial embodiment of the present disclosure. It should be noted that those skilled in the art can also make several improvements and modifications without departing from the principles of the present disclosure, which should be considered as the scope of protection of the present disclosure.

1. A pixel scan method, comprising:
acquiring data signals of each column in a display image of a display panel, and determining data information of the data signals of the column and a correspondence between the data information and pixel units;
determining a first set of pixel units among pixel units of a column to which a first pixel unit belongs, Wherein data information corresponding to the first set of pixel units is the same as data information corresponding to the first pixel unit; and
during a first stage, inputting a scan signal to pixel units of a row to which the first pixel unit belongs and pixel units of rows to which the first set of pixel units belong, to turn on pixel driving circuits of the pixel units of the row to which the first pixel unit belongs and the pixel units of the rows to which the first set of pixel units belong; and inputting a data signal having the data information corresponding to the first pixel unit to the first pixel unit and the first set of pixel units.

2. The method of claim 1, wherein the first pixel unit is a pixel unit at a first row and a first column among pixel units of the display panel.

3. The method of claim 1, wherein determining the data information of the data signals of each column comprises determining same data signals among the data signals of the column in the display image to have same data information.

4. The method of claim 3, wherein determining the correspondence between the data information and the pixel units comprises determining pixel units, to which a same data voltage is input, to correspond to the same data information.

5. The method of claim 3, further comprising:
for pixel units in the column corresponding to same data information, storing one data signal corresponding to one pixel unit among the pixel units and an association between the pixel units and the one data signal.

6. The method of claim 2, after the first stage, further comprising:
determining a second set of pixel units among pixel units of a column to which a second pixel unit belongs, wherein data information corresponding to the second set of pixel units is the same as data information corresponding to the second pixel unit;
during a second stage, inputting the scan signal to pixel units of rows to which the second set of pixel units belong, to turn on pixel driving circuits of the pixel units of the rows to which the second set of pixel units belong; and inputting a data signal having the data information corresponding to the second pixel unit to the second pixel unit and the second set of pixel units, wherein the second pixel unit is a pixel unit at a first row and a second column among pixel units of the display panel.

7. The method of claim 1, further comprising: after the first stage, continuously inputting the scan signal to the pixel units of rows to which the first set of pixel units belong, until input of data signals to the pixel units of rows to which the first set of pixel units belong is completed.

8. The method of claim 1, further comprising: after the first stage, stopping input of the scan signal to the pixel units of rows to which the first set of pixel units belong, to turn off the pixel driving circuits of the pixel units of rows to which the first set of pixel units belong.

9. The method of claim 6, after the second stage, further comprising a data input process, wherein the data input process comprises:
determining an N^{th} set of pixel units among pixel units of an N^{th} column, wherein data information corresponding to the N^{th} set of pixel units is the same as data information corresponding to a pixel unit at a first row and a N^{th} column;
during an N^{th} stage, inputting the scan signal to pixel units of rows to which the N^{th} set of pixel units belong, to turn on pixel driving circuits of the pixel units of the rows to which the N^{th} set of pixel units belong; and inputting a data signal having the data information corresponding to the pixel unit at the first row and the N^{th} column to the pixel unit at the first row and the N^{th} column and the N^{th} set of pixel units,
wherein the data input process is performed starting from N=3 and N is incremented by 1 once the data input process is completed, until N−1 is equal to a total number of columns of all pixel units in the display panel.

10. The method of claim 9, after the N^{th} stage, further comprising:
determining, among pixel units at the first column and other rows other than the first row, a third set of pixel units of which data information is the same as data information corresponding to a pixel unit at a second row and a first column, in response to the data information corresponding to the pixel unit at the second row and the first column being different from the data information corresponding to the pixel unit at the first row and the first column;
during an (N+1)^{th} stage, inputting the scan signal to pixel units of rows to which the third set of pixel units belong and of which pixel diving circuits have not been turned on, to turn on pixel diving circuits of the pixel units of rows to which the third set of pixel units belong and of which pixel driving circuits have not been turned on; and inputting a data signal having the data information corresponding to the pixel unit at the second row and the first column to the pixel unit at the second row and the first column and the third set of pixel units, wherein N is equal to the total number of columns of all pixel units in the display panel.

11. The method of claim 2, further comprising:
skipping the pixel unit at the second row and the first column without inputting a data signal to the pixel unit at the second row and the first column, in response to the data information corresponding to the pixel unit at the second row and the first column being the same as the data information corresponding to the pixel unit at the first row and the first column.

12. The method of claim 2, further comprising:
in a case where input of the data signals is performed on pixel units of reminder rows, pixel units to which the data signals have been input are skipped and the data signals are input only to pixel units to which the data signals have not been input.

13. A pixel scan device, comprising:
a data processor, configured to acquire data signals of each column in a display image of a display panel, and determine data information of the data signals of the column and a correspondence between the data information and pixel units; and determine a first set of pixel units among pixel units of a column to which a first pixel unit belongs, wherein data information corresponding to the first set of pixel units is the same as data information corresponding to the first pixel unit;
a gate driving circuit configured to, during a first stage, input a scan signal to pixel units of a row to which the first pixel unit belongs and pixel units of rows to which the first set of pixel units belong, to turn on pixel driving circuits of the pixel units of the row to which the first pixel unit belongs and the pixel units of the rows to Which the first set of pixel units belong; and
a source driving circuit configured to, during the first stage, input a data signal having the data information corresponding to the first pixel unit to the first pixel unit and the first set of pixel units.

14. The device of claim 13, further comprising:
a data memory, configured to for pixel units in the column corresponding to same data information, store one data signal corresponding to one pixel unit among the pixel units and an association between the pixel units and the one data signal.

15. A display apparatus comprising a processor, a gate driving circuit, a source driving circuit and a plurality of pixel units, each of the plurality of pixel units comprising a pixel driving circuit, the processor being electrically coupled to the gate driving circuit and the source driving circuit, and the pixel driving circuit of each of the plurality of pixel units being electrically coupled to the gate driving circuit and the source driving circuit,
wherein the processor is configured to acquire data signals of each column in a display image of a display panel, determine data information of the data signals of the column and a correspondence between the data information and pixel units, and determine a first set of pixel units among pixel units of a column to which a first pixel unit belongs, wherein data information corresponding to the first set of pixel units is the same as data information corresponding to the first pixel unit;
the gate driving circuit is configured to, during a first stage, input a scan signal to pixel units of a row to which the first pixel unit belongs and pixel units of rows to which the first set of pixel units belong, to turn on pixel driving circuits of the pixel units of the row to which the first pixel unit belongs and the pixel units of the rows to which the first set of pixel units belong; and
the source driving circuit is configured to, during the first stage, input a data signal having the data information corresponding to the first pixel unit to the first pixel unit and the first set of pixel units.

16. The display apparatus of claim 15, wherein the gate driving circuit comprises a first bidirectional shift register and a channel selector electrically coupled with each other; the channel selector being electrically coupled to the pixel driving circuit of each of the pixel units; and
the processor is configured to control the first bidirectional shift register to transmit a high level signal for controlling the pixel driving circuits of pixel units of each row to the channel selector; control the channel selector, according to the high level, to turn on the pixel driving circuits of he pixel units of the row to which the first pixel unit belongs and the pixel units of the rows to which the first set of pixel units belong, during the first stage.

17. The display apparatus of claim 15, wherein the source driving circuit comprises a second bidirectional shift register electrically coupled to the pixel driving circuit of each of the pixel units through a signal line; and
the processor is configured to control the second bidirectional shift register to input the data signal having the data information corresponding to the first pixel unit to the first pixel unit and the first set of pixel units of which the pixel driving circuits have been turned on.

18. A computer readable storage medium, having stored thereon a computer program, the computer program being executed by a processor to implement the method of claim 1.
